(19) United States
(12) Patent Application Publication
(10) Pub. No.: US 2026/0049852 A1
(43) Pub. Date: Feb. 19, 2026

(54) QUANTIFICATION OF LIQUID FLOW RATE AND CORRECTION OF GAS FLOW RATE IN THE PRESENCE OF LIQUID IN A GAS PIPELINE

(71) Applicant: Chevron U.S.A. Inc., San Ramon, CA (US)

(72) Inventors: Pamela Isobel Chacon, Magnolia, TX (US); Lisa Ann Brenskelle, Houston, TX (US); Vinicius Kramer Scariot, Houston, TX (US); Rachel W. Mills, The Woodlands, TX (US)

(21) Appl. No.: 18/807,585

(22) Filed: Aug. 16, 2024

(51) Int. Cl. G01F 1/74; G01F 1/36; G01F 25/10

(52) U.S. Cl. CPC G01F 1/74; G01F 1/36; G01F 25/15

(57) ABSTRACT

Flow restriction differential pressure and a third tap differential pressure for a pipe are used to determine a pressure loss ratio for the pipe/system that includes a flow restriction. The pressure loss ratio is used to determine whether liquid is present in the pipe. If liquid is determined to be present in the pipe, overread or underread of gas flow rate measurement in the pipe is determined and used to correct gas flow rate measurement for the pipe. The liquid flow rate in the pipe is determined.

### FIELD

The present disclosure relates generally to the field of quantifying liquid flow rate and correcting gas flow rate in a gas pipeline based on the presence of liquid in the gas pipeline.

### BACKGROUND

Liquid in a gas pipeline may impact the accuracy of gas flow rate measurement. The presence of liquid in the gas pipeline may cause over/under reading of gas flow rate in the gas pipeline. Determination of liquid quantity in the pipe may have significant impact on revenue.

### SUMMARY

This disclosure relates to correcting gas flow rate in the presence of liquid in a gas pipeline. Measured gas flow rate information, flow restriction differential pressure information, third tap differential pressure information, and/or other information may be obtained. The measured gas flow rate information may define a measured gas flow rate in a pipe. The pipe may include a flow restriction. The flow restriction differential pressure information may define a flow restriction differential pressure between a first point along the pipe and a second point along the pipe. The first point may be on a first side of the flow restriction and the second point may be on a second side of the flow restriction. The third tap differential pressure information may define a third tap differential pressure between the first point along the pipe and a third point along the pipe. The third point may be on the second side of the flow restriction and may be downstream of the second point. A pressure loss ratio may be determined based on the flow restriction differential pressure, the third tap differential pressure, and/or other information. Whether liquid is present in the pipe may be determined based on the pressure loss ratio and/or other information. Responsive to the determination that liquid is present in the pipe, overread or underread of gas flow rate measurement in the pipe may be determined. A liquid-corrected gas flow rate in the pipe may be determined based on the overread or the underread of gas flow rate measurement in the pipe, the measured gas flow rate in the pipe, and/or other information.

A system for correcting gas flow rate in the presence of liquid in a gas pipeline one or more electronic storage, one or more processors and/or other components. The electronic storage may store information relating to a pipe, measured gas flow rate information, information relating to a measured gas flow rate in the pipe, flow restriction differential pressure information, information relating to a flow restriction differential pressure, third tap differential pressure information, information relating to a third tap differential pressure, information relating to a pressure loss ratio, information relating to liquid presence in the pipe, information relating to overread of gas flow rate measurement in the pipe, information relating to underread of gas flow rate measurement in the pipe, information relating to a liquid-corrected gas flow rate in the pipe, and/or other information.

The processor(s) may be configured by machine-readable instructions. Executing the machine-readable instructions may cause the processor(s) to facilitate correcting gas flow rate in the presence of liquid in a gas pipeline. The machine-readable instructions may include one or more computer program components. The computer program components may include one or more of a flow rate component, a differential pressure component, a pressure loss ratio component, a liquid presence component, an overread/underread component, a correction component, and/or other computer program components.

The flow rate component may be configured to obtain measured gas flow rate information and/or other information. The measured gas flow rate information may define a measured gas flow rate in a pipe. The pipe may include a flow restriction.

The differential pressure component may be configured to obtain flow restriction differential pressure information and/or other information. The flow restriction differential pressure information may define a flow restriction differential pressure between a first point along the pipe and a second point along the pipe. The first point may be on a first side of the flow restriction and the second point may be on a second side of the flow restriction.

The differential pressure component may be configured to obtain third tap differential pressure information and/or other information. The third tap differential pressure information may define a third tap differential pressure between the first point along the pipe and a third point along the pipe. The third point may be on the second side of the flow restriction and may be downstream of the second point.

The pressure loss ratio component may be configured to determine a pressure loss ratio. The pressure loss ratio may be determined based on the flow restriction differential pressure, the third tap differential pressure, and/or other information.

The liquid presence component may be configured to determine whether liquid is present in the pipe. Whether liquid is present in the pipe may be determined based on the pressure loss ratio and/or other information.

The overread/underread component may be configured to, responsive to the determination that liquid is present in the pipe, determine overread or underread of gas flow rate measurement in the pipe.

In some implementations, determination of the overread or the underread of gas flow rate measurement in the pipe may include: determination of a value of Lockhart-Martinelli parameter based on a difference between the pressure loss ratio and an ideal pressure loss ratio, and/or other information; determination of an estimated value of the overread or the underread of gas flow rate measurement; determination of a corrected gas flow rate based on the estimated value of the overread or the underread of gas flow rate measurement and/or other information; determination of a value of a gas Froude number based on the corrected gas flow rate and/or other information; and determination of a calculated value of the overread or the underread of gas flow rate measurement based on the value of the Lockhart-Martinelli parameter, the value of the gas Froude number, and/or other information.

In some implementations, the determinations of the corrected gas flow rate, the value of the gas Froude number, and the calculated value of the overread or the underread of gas flow rate measurement may be iterated based on a comparison of the estimated value of the overread or the underread of gas flow rate measurement and the calculated value of the overread or the underread of gas flow rate measurement, and/or other information.

In some implementations, determination of the overread or the underread of gas flow rate measurement in the pipe may include: determination of a value of liquid Froude number based on a difference between the pressure loss ratio and an ideal pressure loss ratio, and/or other information; determination of a liquid flow rate based on the value of the liquid Froude number and/or other information; determination of an estimated value of the overread or the underread of gas flow rate measurement; determination of a corrected gas flow rate based on the estimated value of the overread or the underread of gas flow rate measurement and/or other information; determination of a value of a gas Froude number based on the corrected gas flow rate and/or other information; determination of a value of Lockhart-Martinelli parameter; and determination of a calculated value of the overread or the underread of gas flow rate measurement based on the value of the Lockhart-Martinelli parameter, the value of the gas Froude number, and/or other information.

In some implementations, the determinations of the corrected gas flow rate, the value of the gas Froude number, the value of the Lockhart-Martinelli parameter, and the calculated value of the overread or the underread of gas flow rate measurement may be iterated based on a comparison of the estimated value of the overread or the underread of gas flow rate measurement and the calculated value of the overread or the underread of gas flow rate measurement, and/or other information.

In some implementations, determination of the overread or the underread of gas flow rate measurement in the pipe may include determination of a value of Lockhart-Martinelli parameter using a machine-learning model. The machine-learning model may output the value of the Lockhart-Martinelli parameter based on a difference between the pressure loss ratio and an ideal pressure loss ratio, and/or other information. In some implementations, the machine-learning model may be trained to output the value of the Lockhart-Martinelli parameter based on input of a ratio of the difference between the pressure loss ratio and the ideal pressure loss ratio to geometry of the pipe. In some implementations, the machine-learning model may include a random forest model or an XGBoost model.

The correction component may be configured to determine a liquid-corrected gas flow rate in the pipe. The liquid-corrected gas flow rate in the pipe may be determined based on the overread or the underread of gas flow rate measurement in the pipe, the measured gas flow rate in the pipe, and/or other information.

In some implementations, a liquid flow rate in the pipe may be determined based on the liquid-corrected gas flow rate, the value of the Lockhart-Martinelli parameter, and/or other information. Total transferred liquid over a time period may be determined based on the liquid flow rate and/or other information. Total transferred gas over a time period may be determined based on the liquid-corrected gas flow rate and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for correcting gas flow rate in the presence of liquid in a gas pipeline.

FIG. 2 illustrates an example method for correcting gas flow rate in the presence of liquid in a gas pipeline.

FIG. 3 illustrates an example pipe.

FIG. 4 illustrates an example flow diagram for determining the presence of liquid in a gas pipeline.

FIG. 5A illustrates an example flow diagram for correcting gas flow rate in the presence of liquid in a gas pipeline.

FIG. 5B illustrates an example flow diagram for correcting gas flow rate in the presence of liquid in a gas pipeline.

### DETAILED DESCRIPTION

The present disclosure relates to quantifying liquid flow rate and correcting gas flow rate in the presence of liquid in a gas pipeline. Flow restriction differential pressure and a third tap differential pressure for a pipe are used to determine a pressure loss ratio for the pipe/system that includes a flow restriction. The pressure loss ratio is used to determine whether liquid is present in the pipe. If liquid is determined to be present in the pipe, overread or underread of gas flow rate measurement in the pipe is determined and used to correct gas flow rate measurement for the pipe. The liquid flow rate in the pipe is determined.

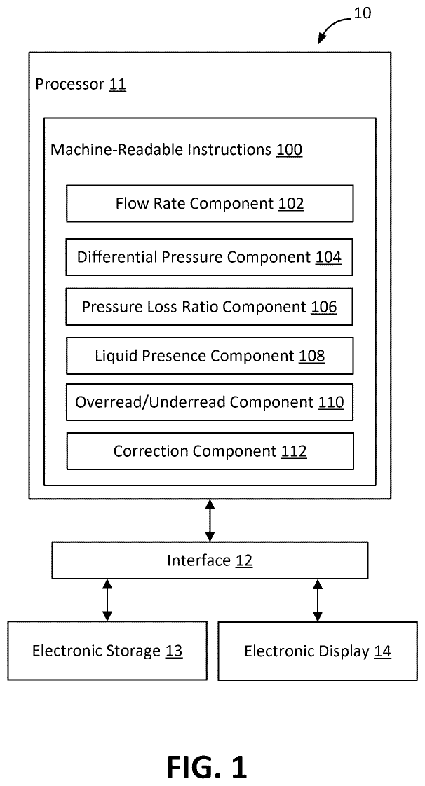

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Measured gas flow rate information, flow restriction differential pressure information, third tap differential pressure information, and/or other information may be obtained by the processor 11. The measured gas flow rate information may define a measured gas flow rate in a pipe. The pipe may include a flow restriction. The flow restriction differential pressure information may define a flow restriction differential pressure between a first point along the pipe and a second point along the pipe. The first point may be on a first side of the flow restriction and the second point may be on a second side of the flow restriction. The third tap differential pressure information may define a third tap differential pressure between the first point along the pipe and a third point along the pipe. The third point may be on the second side of the flow restriction and may be downstream of the second point. A pressure loss ratio may be determined by the processor 11 based on the flow restriction differential pressure, the third tap differential pressure, and/or other information. Whether liquid is present in the pipe may be determined by the processor 11 based on the pressure loss ratio and/or other information. Responsive to the determination that liquid is present in the pipe, overread or underread of gas flow rate measurement in the pipe may be determined by the processor 11. A liquid-corrected gas flow rate in the pipe may be determined by the processor 11 based on the overread or the underread of gas flow rate measurement in the pipe, the measured gas flow rate in the pipe, and/or other information.

The electronic storage 13 may be configured to include electronic storage media that electronically stores information. The electronic storage 13 may store software algorithms, information determined by the processor 11, information received remotely, and/or other information that enables the system 10 to function properly. For example, the electronic storage 13 may store information relating to a pipe, measured gas flow rate information, information relating to a measured gas flow rate in the pipe, flow restriction differential pressure information, information relating to a flow restriction differential pressure, third tap differential pressure information, information relating to a third tap differential pressure, information relating to a pressure loss ratio, information relating to liquid presence in the pipe, information relating to the liquid flow rate in the pipe, information relating to overread of gas flow rate measurement in the pipe, information relating to underread of gas flow rate measurement in the pipe, information relating to a liquid-corrected gas flow rate in the pipe, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a pipe, measured gas flow rate information, information relating to a measured gas flow rate in the pipe, flow restriction differential pressure information, information relating to a flow restriction differential pressure, third tap differential pressure information, information relating to a third tap differential pressure, information relating to a pressure loss ratio, information relating to liquid presence in the pipe, information relating to overread of gas flow rate measurement in the pipe, information relating to underread of gas flow rate measurement in the pipe, information relating to a liquid-corrected gas flow rate in the pipe, and/or other information.

Accurately measuring flow of gas and liquid in a gas pipeline may be critical for many applications, such as reservoir and well management, production optimization, flow assurance issues, production allocation, and custody transfer. The presence of liquid in a pipe may reduce the accuracy of gas flow rate measurement in the pipe. For example, liquid flowing in a pipe may result in overread/underread of gas flow rate measurement in the pipe. Liquid flowing in a pipe may result in the measured gas flow rate being higher or lower than the actual gas flow rate in the pipe. Quantifying the liquid in the pipe may enable more accurate measurement of gas flow rate in the pipe and allow for liquid transfer through the pipe to be measured. However, existing wet gas (gas that includes/carries liquid) meters leverage multiple measurement components and are costly to install and maintain.

The current disclosure provides a simple and low-cost supplemental add-on to a flow restriction (e.g., an orifice plate, a Venturi, a cone, or a wedge meter) in a pipe to accurately quantify liquid in the pipe (e.g., liquid fraction in the pipe) and enable accurate measurement of gas flow rate in the pipe. The current disclosure also enables liquid transfer through the pipe to be accurately measured (estimated, calculated). The current disclosure utilizes a third tap for the flow restriction to determine whether liquid is present in the pipe. When liquid is detected in the pipe, the current disclosure iteratively determines the value of the overread/underread until convergence is reached between the estimated value and the calculated value of the overread/underread. The overread/underread is used to account for the effects of the liquid presence on gas flow rate measurement and correct the gas flow rate measurement in the pipe. The liquid flow rate in the pipe is determined.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate quantifying liquid flow rate and correcting gas flow rate in the presence of liquid in a gas pipeline. The machine-readable instructions 100 may include one or more computer program components. The machine-readable instructions 100 may include a flow rate component 102, a differential pressure component 104, a pressure loss ratio component 106, a liquid presence component 108, an overread/underread component 110, a correction component 112, and/or other computer program components.

The flow rate component 102 may be configured to obtain measured gas flow rate information and/or other information. Obtaining measured gas flow rate information may include one or more of accessing, acquiring, analyzing, determining, examining, generating, identifying, loading, locating, measuring, opening, receiving, retrieving, reviewing, selecting, storing, and/or otherwise obtaining the measured gas flow rate information. The flow rate component 102 may obtain measured gas flow rate information from one or more locations. For example, the flow rate component 102 may obtain measured gas flow rate information from a storage location, such as the electronic storage 13, electronic storage of a device accessible via a network, and/or other locations. The flow rate component 102 may obtain measured gas flow rate information from one or more hardware components (e.g., a computing device, a gas flow sensor/meter) and/or one or more software components (e.g., software running on a computing device).

For example, the flow rate component 102 may obtain measured gas flow rate information by using one or more gas flow sensors to measure the gas flow rate in a pipe. One or more types of gas flow sensors (e.g., an orifice plate, a Venturi, a cone, or a wedge meter) may be used to measure the gas flow rate in the pipe. The gas flow rate in the pipe may be measured using a flow restriction and/or other devices. For example, the gas flow rate in the pipe may be measured using static pressure reading, differential pressure reading, gas composition in the pipe, the temperature in the pipe, and/or other information.

The measured gas flow rate information may define a measured gas flow rate in a pipe. The measured gas flow rate in the pipe may refer to the gas flow rate measured in the pipe using one or more sensors/computing devices. The measured gas flow rate in the pipe may refer to the measured rate at which gas is flowing through the pipe. The measured gas flow rate in the pipe may include the volume flow rate and/or mass flow rate. The measured gas flow rate may include an error (overread/underread) caused by the presence of liquid in the pipe.

The measured gas flow rate information may define a measured gas flow rate in a pipe by including information that characterizes, conveys, describes, delineates, identifies, is associated with, quantifies, reflects, sets forth, and/or otherwise defines one or more of value, property, quality, quantity, attribute, feature, and/or other aspects of the measured gas flow rate in the pipe. The measured gas flow rate information may directly and/or indirectly define a measured gas flow rate in a pipe. For example, the measured gas flow rate information may define a measured gas flow rate in a pipe by including information that specifies the value of the measured gas flow rate in the pipe and/or information that may be used to determine the value of the measured gas flow rate in the pipe. Other types of measured gas flow rate information are contemplated.

The pipe in which the gas flow rate is measured may include one or more flow restrictions. A flow restriction may refer to one or more devices and/or one or more configurations of a pipe that restricts the flow of fluid through the pipe. A flow restriction may change the cross-sectional area of the pipe through which fluid flows. A flow restriction may be part of the pipe. A flow restriction may be installed in the pipe. A flow restriction may be a single-phase differential pressure-based flow measurement device. For example, a flow restriction on a pipe may include an orifice plate, a Venturi, a cone, or a wedge meter. Use of other types of flow restriction is contemplated.

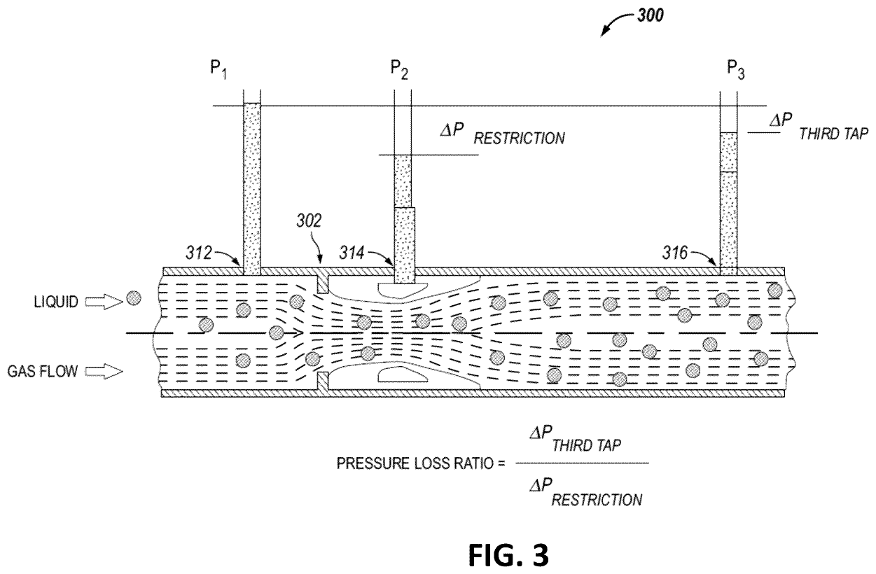

For example, FIG. 3 illustrates an example pipe 300. The flow restriction on the pipe 300 may include an orifice plate 302. The orifice plate 302 may be located along the pipe 300. The orifice plate 302 may include a thin plate with a hole. While the pipe 300 in FIG. 3 is shown with an orifice plate, the pipe 300 is merely provided as an example and is not meant to be limiting. Use of other types of flow restriction is contemplated.

The differential pressure component 104 may be configured to obtain differential pressure information and/or other information. Obtaining differential pressure information may include one or more of accessing, acquiring, analyzing, determining, examining, generating, identifying, loading, locating, measuring, opening, receiving, retrieving, reviewing, selecting, storing, and/or otherwise obtaining the differential pressure information. The differential pressure component 104 may obtain differential pressure information from one or more locations. For example, the differential pressure component 104 may obtain differential pressure information from a storage location, such as the electronic storage 13, electronic storage of a device accessible via a network, and/or other locations. The differential pressure component 104 may obtain differential pressure information from one or more hardware components (e.g., a computing device, a pressure sensor, a differential pressure sensor) and/or one or more software components (e.g., software running on a computing device). For example, the differential pressure component 104 may obtain differential pressure information by using one or more pressure sensors and/or one or more differential pressure sensors to measure the differential pressure between two different points (locations) along a pipe. In some implementations, a pressure sensor may include a fast response pressure sensor (dynamic pressure sensor). In some implementations, a differential pressure sensor may include a fast response differential pressure sensor.

The differential pressure information may define a differential pressure between two points along a pipe. The differential pressure between two points along a pipe may refer to the difference in pressure between the two points along the pipe. The differential pressure information may define a differential pressure between two points along a pipe by including information that characterizes, conveys, describes, delineates, identifies, is associated with, quantifies, reflects, sets forth, and/or otherwise defines one or more of value, property, quality, quantity, attribute, feature, and/or other aspects of the differential pressure between the two points along the pipe. The differential pressure information may directly and/or indirectly define a differential pressure between two points along a pipe. For example, the differential pressure information may define a differential pressure between two points along a pipe by including information that specifies the value of the differential pressure between the two points along the pipe and/or information that may be used to determine the value of the differential pressure between the two points along the pipe (e.g., the values of two pressure measurements at the two points along the pipe from which the differential pressure between the two points may be calculated). Other types of differential pressure information are contemplated.

Differential pressure information obtained by the differential pressure component 104 may include flow restriction differential pressure information, third tap differential pressure information, and/or other differential pressure information. The flow restriction differential pressure information may define a flow restriction differential pressure between two points along a pipe. A flow restriction differential pressure may refer to a differential pressure measured using a flow restriction. A flow restriction differential pressure may refer to a difference in pressure between two different sides of a flow restriction. For example, referring to FIG. 3, the pipe 300 may include holes (taps) to measure pressure at different points 312, 314, 316 along the pipe. The flow restriction differential pressure (ΔP_{restriction}) may refer to the difference in pressure between the point 312 and the point 314 along the pipe 300. The points 312, 314 may be on different sides of the orifice plate 302.

Differential pressure information between other locations of the pipe may be obtained. For example, differential pressure may be measured upstream and/or downstream from a flow restriction. The taps to measure pressure at different points along the pipe may be located before the flow restriction to obtain upstream differential pressure. The taps to measure pressure at different points along the pipe may be located after the flow restriction to obtain downstream differential pressure. As another example, differential pressure may be measured from different locations on the circumference of the pipe. For example, rather than having the taps aligned along the pipe (e.g., the tap 312 and the tap 314 located at the top of the pipe 300 as shown in FIG. 3), the taps may not be aligned along the pipe (e.g., taps located at the top and the sides/bottom of the pipe). The taps may also be aligned but located at other points along the pipe circumference (i.e., not the top). Other locations for differential pressure/flow restriction differential pressure measurement are contemplated.

The third tap differential pressure information may define a third tap differential pressure between two points along the pipe. One of the two points for the measurement of the third tap differential pressure may be the same as one of the two points for the measurement of the flow restriction differential pressure. The other one of the two points for the measurement of the third tap differential pressure may be at a third tap for the pipe and may be different from the two points for the measurement of the flow restriction differential pressure. The third tap may be located downstream from the holes for the flow restriction differential pressure measurement.

For example, referring to FIG. 3, the third tap may be located at the point 316. The third tap differential pressure (ΔP_{third tap}) may refer to the difference in pressure between the point 312 and the point 316 along the pipe 300. The points 314, 316 may be on the same side of the orifice plate 302. The point 316 may be downstream of the point 314. Other locations of the third tap/hole for third tap different pressure measurement are contemplated.

The pressure loss ratio component 106 may be configured to determine a pressure loss ratio. Determining the pressure loss ratio may include ascertaining, approximating, calculating, establishing, estimating, finding, identifying, obtaining, quantifying, selecting, setting, and/or otherwise determining the pressure loss ratio. Determining the pressure loss ratio may include determining the value of the pressure loss ratio. The pressure loss ratio may be determined based on the flow restriction differential pressure, the third tap differential pressure, and/or other information. The pressure loss ratio determined based on the flow restriction differential pressure and the third tap differential pressure may be referred to as the measured pressure loss ratio (PLR_{measured}). The pressure loss ratio may be determined as a ratio of the third tap differential pressure and the flow restriction differential pressure:

$${PLR}_{measured} = \frac{Δ {P}_{third tap}}{Δ {P}_{restriction}}$$

The liquid presence component 108 may be configured to determine whether liquid is present in the pipe. Determining whether liquid is present in the pipe may include determining whether wet gas or dry gas is flowing through the pipe. Determining whether liquid is present in the pipe may include determining whether liquid is flowing in the pipe. Whether liquid is present in the pipe may be determined based on the pressure loss ratio and/or other information. The value of the pressure loss ratio may be used to determine whether the gas that is flowing through the pipe includes/is carrying liquid.

In some implementations, the determination of whether liquid is present in the pipe based on the pressure loss ratio may include comparison of a difference between the pressure loss ratio and an ideal pressure loss ratio to a threshold to determine whether liquid is present in the pipe. The ideal pressure loss ratio may refer to the value of pressure loss ratio that would be present for transport of a single phase gas through the pipe. The ideal pressure loss ratio may refer to the value of pressure loss ratio when liquid is not present in gas flowing through the pipe. The ideal pressure loss ratio may be referred to as the single-phase pressure loss ratio. The difference between the pressure loss ratio in the pipe and the ideal pressure loss ratio may indicate how far the condition in the pipe is from a single phase condition (gas only condition). When liquid is present in the pipe, the pressure loss ratio in the pipe may deviate from the ideal pressure loss ratio. The difference between the pressure loss ratio in the pipe and the ideal pressure loss ratio may be denoted as Y_{PLR}. The difference between the pressure loss ratio in the pipe and the ideal pressure loss ratio may be referred to as the pressure loss ratio departure from single-phase flow.

Comparison of the difference between the pressure loss ratio and the ideal pressure loss ratio (the pressure loss ratio departure from single-phase flow, Y_{PLR}) to a threshold may enable control of how far the pressure loss ratio can deviate from the ideal pressure loss ratio before liquid is determined to be present in the pipe. The value of the threshold may control how far the pressure loss ratio can deviate from the ideal pressure loss ratio/single-phase pressure loss ratio before liquid is determined to be present in the pipe. For example, small deviation of the pressure loss ratio from the ideal pressure loss ratio (deviation less than the threshold) may be ignored while large deviation of the pressure loss ratio from the ideal pressure loss ratio (deviation greater than the threshold) may indicate that liquid is present in the pipe.

Example comparison of the difference between the pressure loss ratio and the single-phase pressure loss ratio to a threshold is provided below:

$$\frac{{PLR}_{measured} - {PLR}_{single - phase}}{{PLR}_{single - phase}} * 100 \% > Threshold \%$$

$${PLR}_{single - phase} = \frac{\sqrt{1 - {β}^{4} ( 1 - {C}_{d}^{2} )} - {C}_{d} {β}^{2}}{\sqrt{1 - {β}^{4} ( 1 - {C}_{d}^{2} )} + {C}_{d} {β}^{2}}$$

where

$$β = \frac{d}{D} ,$$

d=orifice diameter, D=pipe diameter, C_{d}=coefficient of discharge

In the above, the single-phase pressure loss ratio may be calculated using an ISO correlation. Other calculation of the ideal pressure loss ratio is contemplated.

In some implementations, the determination of whether liquid is present in the pipe based on the pressure loss ratio may include comparison of the value of the pressure loss ratio to a dry value of the pressure loss ratio and/or a liquid value of the pressure loss ratio. A dry value of the pressure loss ratio may refer to a value of the pressure loss ratio when the pipe is known to not include any liquid. For example, the pressure loss ratio may be computed when the pipe is known to not include any liquid, and this value of the pressure loss ratio (dry gas baseline value) may be compared with the current pressure loss ratio to determine whether the pipe is currently dry (not including liquid) or wet (including liquid). A liquid value of the pressure loss ratio may refer to a value of the pressure loss ratio when the pipe is known to include liquid. For example, the pressure loss ratio may be computed when the pipe is known to include a certain amount of liquid (e.g., the smallest amount of liquid for which liquid presence is desired to be detected), and this value of the pressure loss ratio (wet gas baseline value) may be compared with the current pressure loss ratio to determine whether the pipe is currently dry or wet.

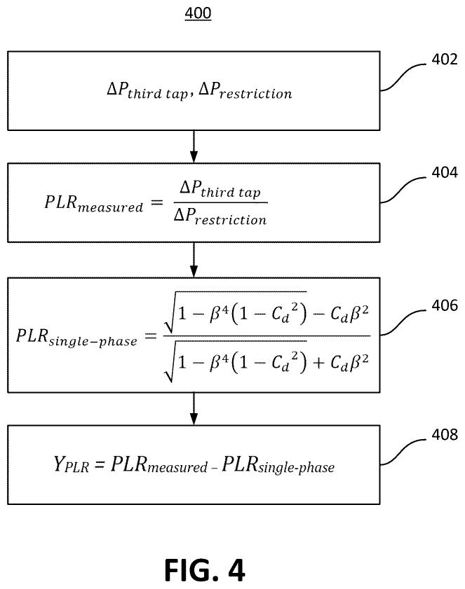

FIG. 4 illustrates an example flow diagram 400 for determining the presence of liquid in a gas pipeline. At step 402, a flow restriction differential pressure and a third tap differential pressure may be obtained. At step 404, a measured pressure loss ratio may be calculated as a ratio of the third tap differential pressure and the flow restriction differential pressure. At step 406, a single-phase pressure loss ratio for the pipe may be calculated. At step 408, a difference between the measured pressure loss ratio and the single-phase pressure loss ratio (a pressure loss ratio departure from single-phase flow, Y_{PLR}) may be determined. The difference between the measured pressure loss ratio and the single-phase pressure loss ratio may be compared to a threshold to determine if liquid is present in the pipe. For example, the difference between the measured pressure loss ratio and the single-phase pressure loss ratio may be compared to a threshold to determine if the gas in the pipe is carrying liquid (e.g., carrying any liquid, carrying sufficient amount of liquid). If the gas in the pipe is not carrying liquid (e.g., not carrying any liquid, not carrying sufficient amount of liquid), the process may return to step 402. If the gas in the pipe is carrying liquid, the gas flow rate measured in the pipe may include an error (overread/underread), and the measured gas flow rate in the pipe may be corrected via calculation of the error in the gas flow rate measurement.

The overread/underread component 110 may be configured to, responsive to the determination that liquid is present in the pipe, determine overread or underread of gas flow rate measurement in the pipe. Determining the overread or the underread of gas flow rate measurement in the pipe may include ascertaining, approximating, calculating, establishing, estimating, finding, identifying, obtaining, quantifying, selecting, setting, and/or otherwise determining the overread or the underread of gas flow rate measurement in the pipe. Determining the overread or the underread of gas flow rate measurement in the pipe may include determining the value of the overread or the underread of gas flow rate measurement in the pipe.

In some implementations, determination of the overread or the underread of gas flow rate measurement in the pipe may include: determination of a value of Lockhart-Martinelli parameter based on the difference between the pressure loss ratio and the ideal pressure loss ratio, and/or other information; determination of an estimated value of the overread or the underread of gas flow rate measurement; determination of a corrected gas flow rate based on the estimated value of the overread or the underread of gas flow rate measurement and/or other information; determination of a value of a gas Froude number based on the corrected gas flow rate and/or other information; and determination of a calculated value of the overread or the underread of gas flow rate measurement based on the value of the Lockhart-Martinelli parameter, the value of the gas Froude number, and/or other information.

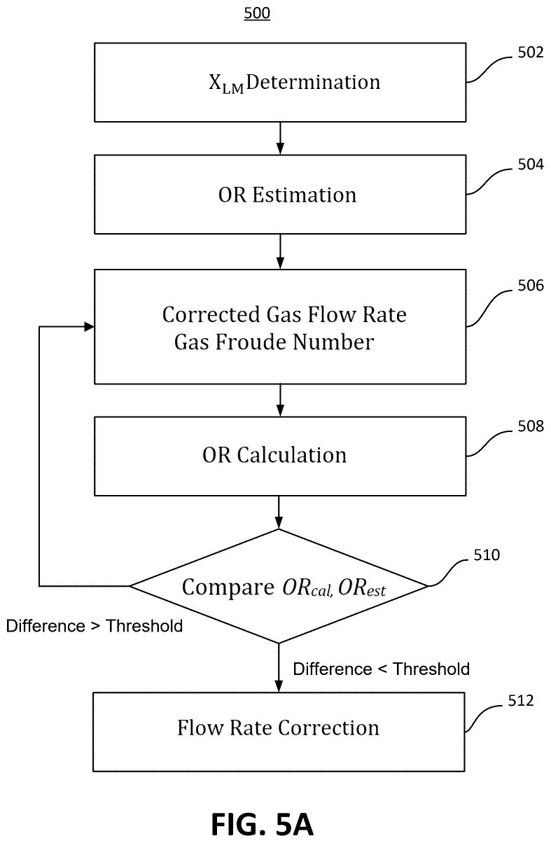

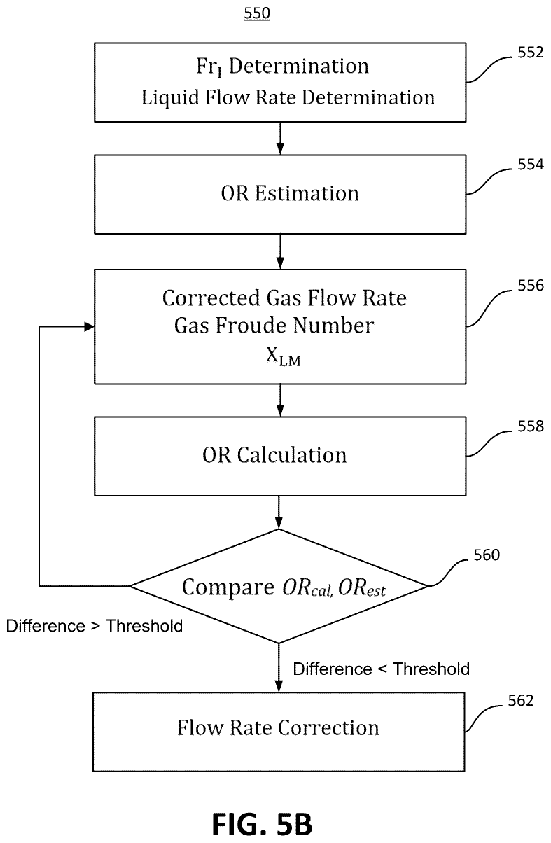

FIG. 5A illustrates an example flow diagram 500 for correcting gas flow rate in the presence of liquid in a gas pipeline. While FIG. 5A shows use of the overread of gas flow rate measurement, this is merely as an example and is not meant to be limiting. In some implementations, the underread of gas flow rate measurement may be used. While FIG. 5A is described with respect to gas mass flow rate (m_{g}), this is merely as an example and is not meant to be limiting. In some implementations, the gas volume flow rate (Q_{g}) may be used.

At step 502, the value of the Lockhart-Martinelli parameter may be determined. For example, the value of the Lockhart-Martinelli parameter may be determined as a function of the difference between the pressure loss ratio and an ideal pressure loss ratio (the pressure loss ratio departure from single-phase flow, Y_{PLR}), as set forth below. In the below, the terms a₁, a₂, a₃, and a₄ may be constants. The constant terms may be calculated based on experimental and/or simulation results. The constant terms may be determined based on experiments and/or simulations of different amounts of liquid presence in the pipe. The constant terms may be calculated for specific pipe (e.g., pipe dimensions, pipe materials), specific gas (e.g., gas composition), and/or specific liquid (e.g., liquid composition). Other determinations of the value of the Lockhart-Martinelli parameter are contemplated.

$${X}_{L M} = {a}_{1} {Y}_{PLR}^{2} + {a}_{2} {Y}_{PLR} β + {a}_{3} {Y}_{PLR} D R + {a}_{4} {Y}_{PLR} ,$$

where

$$DR = \frac{{ρ}_{g}}{{ρ}_{l}} ,$$

ρ_{g}=gas density, ρₗ=liquid density, and

$$β = \frac{d}{D} ,$$

d=orifice diameter, D=pipe diameter

At step 504, the estimated value of the overread (OR_{EST}) of gas flow rate measurement may be determined. In some implementations, the estimated value of the overread of gas flow rate measurement may be determined as one. Other estimations of the overread of gas flow rate measurement are contemplated.

At step 506, the corrected gas flow rate may be determined based on the estimated value of the overread of gas flow rate measurement and/or other information. For example, the corrected gas flow rate (m_{g,corrected}) may be determined based on the measured gas flow rate (m_{g,measured}) and the estimated value of overread (OR) of the gas flow rate measurement using the below relationship.

$${m}_{g , corrected} = \frac{{m}_{g , measured}}{OR}$$

The value of the gas Froude number (Fr_{g}) may be determined based on the corrected gas flow rate and/or other information. For example, the corrected gas flow rate may be used to determine the superficial gas velocity (Vs_{g}), and the superficial gas velocity may be used to determine the value of the gas Froude number using the below relationships. Other determinations of the gas Froude number are contemplated.

$${Vs}_{g} = \frac{{m}_{g corrected}}{{ρ}_{g} {A}_{p}} ,$$

where ρ_{g} is the density of gas and Aₚ is the cross-sectional area of the pipe

$${Fr}_{g} = \sqrt{\frac{Superticial Gas Inertia Force}{Liquid Gravity Force}} = \frac{V {s}_{g}}{\sqrt{g \cdot D}} \cdot \sqrt{\frac{{ρ}_{g}}{{ρ}_{l} - {ρ}_{g}}} ,$$

where g is acceleration due to gravity, and D is pipe diameter

At step 508, the calculated value of the overread (OR_{CAL}) of gas flow rate measurement may be determined based on the value of the Lockhart-Martinelli parameter, the value of the gas Froude number, and/or other information. The calculated value of the overread of gas flow rate measurement may be determined as a function of the Lockhart-Martinelli parameter, the gas Froude number, the density ratio of gas to liquid, and the water to liquid mass ratio. For example, the calculated value of the overread of gas flow rate measurement may be determined using the below relationships from ISO TR 12748. Other determinations of the overread are contemplated.

$$OR = \sqrt{1 + C \cdot {X}_{LM} + {X}_{LM}^{2}} , where C = {( \frac{{ρ}_{g}}{{ρ}_{l}} )}^{n} + {( \frac{{ρ}_{l}}{{ρ}_{g}} )}^{n}$$

water to liquid mass ratio,

$$WLMR = \frac{{\dot{m}}_{w}}{{\dot{m}}_{l}} ,$$

where \dot{m}_{w} is mass of water and \dot{m}ₗ is mass of liquid

$$A = 0.4 - 0.1 * exp ( - WLMR )$$

$${Fr}_{g , transition} = 1.5 + 0.2 * WLMR$$

$$if {Fr}_{g} < {Fr}_{g , transition} \to n = {( \frac{1}{\sqrt{2}} - \frac{A}{\sqrt{F {r}_{g , transition}}} )}^{2}$$

$$if {Fr}_{g} > {Fr}_{g , transition} \to n = {( \frac{1}{\sqrt{2}} - \frac{A}{\sqrt{{Fr}_{g}}} )}^{2}$$

In some implementations, the determinations of the corrected gas flow rate, the value of the gas Froude number, and the calculated value of the overread or the underread of gas flow rate measurement may be iterated based on a comparison of the estimated value of the overread or the underread of gas flow rate measurement and the calculated value of the overread or the underread of gas flow rate measurement, and/or other information. The determinations may be iterated until convergence in the value of the overread or the underread of gas flow rate measurement is achieved. Individual iterations may include determination of a new value of the corrected gas flow rate based on the latest calculated value of the overread/underread and determination of the corresponding value of the gas Froude number. The new value of the gas Froude number may be used to determine a new calculated value of the overread/underread. Whether the iteration will continue may be determined based on a comparison of the latest calculated value of the overread/underread in the current iteration (“calculated” overread/underread) and the previously calculated or estimated value of the overread/underread (the overread/underread calculated in the previous iteration, “estimated” overread/underread), and/or other information. When the difference between the latest calculated value of the overread/underread and the previously calculated/estimated value of the overread/underread is below a threshold value, the value of the overread/underread may be deemed to have converged and the iteration may be stopped.

For example, referring to FIG. 5A, at step 510, a comparison may be performed to determine whether another iteration will be performed. The comparison may determine the difference between the estimated overread (OR_{EST}) of gas flow rate measurement and the calculated overread (OR_{CAL}) of gas flow rate measurement. For the initial iteration, the estimated overread (OR_{EST}) may be the value obtained at step 504. For later iterations, the estimated overread (OR_{EST}) may be the calculated overread from the prior iteration (OR_{CAL, Prior}), step 508 of the previous iteration. If the difference is higher than a threshold value, another iteration may be performed by returning to step 506. At step 506, the latest calculated value of the overread may be used to determine the new value of the corrected gas flow rate. If the difference is lower than the threshold value, the value of the overread of gas flow rate measurement may be deemed to have converged and the iteration may be stopped. At step 512, gas flow rate correction may be output. In some implementations, the value of the corrected gas flow rate determined from step 506 of the latest iteration may be output. In some implementations, a new value of the corrected gas flow rate may be calculated using the latest/converged calculated value of the overread and the new value may be output.

In some implementations, the value of the liquid flow rate may be determined based on the value of the corrected gas flow rate and/or other information. For example, the value of the liquid flow rate in the pipe may be determined based on value of the corrected gas flow rate, the value of the Lockhart-Martinelli parameter, and/or other information. In some implementations, the value of the liquid flow rate may be determined in each iteration (e.g., after determination of the value the corrected gas flow rate). In some implementations, the value of the liquid flow rate may be determined after the overread value has converged/the value of corrected gas flow rate to be output has been determined. The value of the liquid flow rate may be reported (e.g., with or separately from the value of the corrected gas flow rate).

In some implementations, determination of the overread or the underread of gas flow rate measurement in the pipe may include: determination of a value of liquid Froude number based on the difference between the pressure loss ratio and the ideal pressure loss ratio, and/or other information; determination of a liquid flow rate based on the liquid Froude number and/or other information; determination of an estimated value of the overread or the underread of gas flow rate measurement; determination of a corrected gas flow rate based on the estimated value of the overread or the underread of gas flow rate measurement and/or other information; determination of a value of a gas Froude number based on the corrected gas flow rate and/or other information; determination of a value of Lockhart-Martinelli parameter; and determination of a calculated value of the overread or the underread of gas flow rate measurement based on the value of the Lockhart-Martinelli parameter, the value of the gas Froude number, and/or other information.

FIG. 5B illustrates an example flow diagram 550 for correcting gas flow rate in the presence of liquid in a gas pipeline. While FIG. 5B shows use of the overread of gas flow rate measurement, this is merely as an example and is not meant to be limiting. In some implementations, the underread of gas flow rate measurement may be used. While FIG. 5B is described with respect to liquid mass flow rate (mₗ), this is merely as an example and is not meant to be limiting. In some implementations, the liquid volume flow rate (Qₗ) may be used.

At step 552, the value of liquid Froude number (Frₗ) may be determined. For example, the value of liquid Froude number may be determined as a function of the difference between the pressure loss ratio and an ideal pressure loss ratio (the pressure loss ratio departure from single-phase flow, Y_{PLR}), as set forth below. In the below, the terms b₁, b₂, b₃, and b₄ may be constants. The constant terms may be calculated based on experimental and/or simulation results. The constant terms may be determined based on experiments and/or simulations of different amounts of liquid presence in the pipe. The constant terms may be calculated for specific pipe (e.g., pipe dimensions, pipe materials), specific gas (e.g., gas composition), and/or specific liquid (e.g., liquid composition). Other determinations of the value of liquid Froude number are contemplated.

$${Fr}_{1} = {b}_{1} {Y}_{PLR}^{2} + {b}_{2} {Y}_{PLR} β + {b}_{3} {Y}_{PLR} DR + {b}_{4} {Y}_{PLR} ,$$

where

$$DR = \frac{{ρ}_{g}}{{ρ}_{l}} ,$$

ρ_{g}=gas density, ρₗ=liquid density, and

$$β = \frac{d}{D} ,$$

d=orifice diameter, D=pipe diameter

The liquid flow rate may be determined based on the liquid Froude number and/or other information. For example, the liquid flow rate (mₗ) may be determined using the below relationships. Other determinations of the liquid flow rate are contemplated.

$${Fr}_{l} = \sqrt{\frac{Superficial Gas Inertia Force}{Liquid Gravity Force}} = \frac{{Vs}_{l}}{\sqrt{g \cdot D}} \cdot \sqrt{\frac{{ρ}_{l}}{{ρ}_{l} - {ρ}_{g}}} ,$$

Where Vsₗ is superficial liquid velocity, g is acceleration due to gravity, D is pipe diameter, ρ_{g} is the density of gas, and ρₗ is the density of liquid

$${m}_{l calculated} = {Vs}_{l} {ρ}_{l} {A}_{p} ,$$

where Aₚ is the cross-sectional area of the pipe

At step 554, the estimated value of the overread (OR_{EST}) of gas flow rate measurement may be determined. In some implementations, the estimated value of the overread of gas flow rate measurement may be determined as one. Other estimations of the overread of gas flow rate measurement are contemplated.

At step 556, the corrected gas flow rate may be determined based on the estimated value of the overread of gas flow rate measurement and/or other information. For example, the corrected gas flow rate (m_{g,corrected}) may be determined based on the measured gas flow rate (m_{g,measured}) and the estimated value of overread (OR) of the gas flow rate measurement using the below relationship.

$${m}_{g , corrected} = \frac{{m}_{g , measured}}{OR}$$

The value of the gas Froude number (Fr_{g}) may be determined based on the corrected gas flow rate and/or other information. For example, the corrected gas flow rate may be used to determine the superficial gas velocity (Vs_{g}), and the superficial gas velocity may be used to determine the value of the gas Froude number using the below relationships. Other determinations of the gas Froude number are contemplated.

$${Vs}_{g} = \frac{{m}_{g , corrected}}{{ρ}_{g} {A}_{p}} ,$$

where ρ_{g} is the density of gas and Aₚ is the cross-sectional area of the pipe

$${Fr}_{g} = \sqrt{\frac{Superficial Gas Inertia Force}{Liquid Gravity Force}} = \frac{{Vs}_{g}}{\sqrt{g \cdot D}} \cdot \sqrt{\frac{{ρ}_{g}}{{ρ}_{l} - {ρ}_{g}}} ,$$

where g is acceleration due to gravity, and D is pipe diameter

The value of the Lockhart-Martinelli parameter may be determined based on the liquid flow rate, the corrected gas flow rate, and/or other information. For example, the value of the Lockhart-Martinelli parameter may be determined using the below relationship.

$${X}_{LM} = \frac{{m}_{l}}{{m}_{g , corrected}} \sqrt{\frac{{ρ}_{g}}{{ρ}_{l}}}$$

At step 558, the calculated value of the overread (OR_{CAL}) of gas flow rate measurement may be determined based on the value of the Lockhart-Martinelli parameter, the value of the gas Froude number, and/or other information. The calculated value of the overread of gas flow rate measurement may be determined as a function of the Lockhart-Martinelli parameter, the gas Froude number, the density ratio of gas to liquid, and the water to liquid mass ratio. For example, the calculated value of the overread of gas flow rate measurement may be determined using the below relationships from ISO TR 12748.

$$OR = \sqrt{1 + C \cdot {X}_{LM} + {X}_{LM}^{2}} , where C = {( \frac{{ρ}_{g}}{{ρ}_{l}} )}^{n} + {( \frac{{ρ}_{l}}{{ρ}_{g}} )}^{n}$$

water to liquid mass ratio,

$$WLMR = \frac{{\dot{m}}_{w}}{{\dot{m}}_{l}} ,$$

where \dot{m}_{w} is mass of water and \dot{m}ₗ is mass of liquid

$$A = 0.4 - 0.1 * exp ( - WLMR )$$

$${Fr}_{g , transition} = 1.5 + 0.2 * WLMR$$

$$if {Fr}_{g} < {Fr}_{g , transition} \to n = {( \frac{1}{\sqrt{2}} - \frac{A}{\sqrt{{Fr}_{g , transition}}} )}^{2}$$

$$if {Fr}_{g} > {Fr}_{g , transition} \to n = {( \frac{1}{\sqrt{2}} - \frac{A}{\sqrt{{Fr}_{g}}} )}^{2}$$

In some implementations, the determinations of the corrected gas flow rate, the value of the gas Froude number, the value of the Lockhart-Martinelli parameter, and the calculated value of the overread or the underread of gas flow rate measurement may be iterated based on a comparison of the estimated value of the overread or the underread of gas flow rate measurement and the calculated value of the overread or the underread of gas flow rate measurement, and/or other information. The determinations may be iterated until convergence in the value of the overread or the underread of gas flow rate measurement is achieved. Individual iterations may include determination of a new value of the corrected gas flow rate based on the latest calculated value of the overread/underread and determination of the corresponding values of the gas Froude number and the Lockhart-Martinelli parameter. The new values of the gas Froude number and the Lockhart-Martinelli parameter may be used to determine a new calculated value of the overread/underread. Whether the iteration will continue may be determined based on a comparison of the latest calculated value of the overread/underread in the current iteration (“calculated” overread/underread) and the previously calculated value of the overread/underread (the overread/underread calculated in the previous iteration, “estimated” overread/underread), and/or other information. When the difference between the latest calculated value of the overread/underread and the previously calculated value of the overread/underread is below a threshold value, the value of the overread/underread may be deemed to have converged and the iteration may be stopped.

For example, referring to FIG. 5B, at step 560, a comparison may be performed to determine whether another iteration will be performed. The comparison may determine the difference between the estimated overread (OR_{EST}) of gas flow rate measurement and the calculated overread (OR_{CAL}) of gas flow rate measurement. For the initial iteration, the estimated overread (OR_{EST}) may be the value obtained at step 554. For later iterations, the estimated overread (OR_{EST}) may be the calculated overread from the prior iteration (OR_{CAL,Prior}). If the difference is higher than a threshold value, another iteration may be performed by returning to step 556. At step 556, the latest calculated value of the overread may be used to determine the new value of the corrected gas flow rate. If the difference is lower than the threshold value, the value of the overread of gas flow rate measurement may be deemed to have converged and the iteration may be stopped. At step 562, gas flow rate correction may be output. In some implementations, the value of the corrected gas flow rate determined from step 556 of the latest iteration may be output. In some implementations, a new value of the corrected gas flow rate may be calculated using the latest/converged calculated value of the overread and the new value may be output.

In some implementations, one or more parameters (e.g., Lockhart-Martinelli parameter, liquid Froude number) for quantification of liquid flow rate and/or correction of gas flow rate may be determined using one or more machine-learning models. For instance, determination of the overread or the underread of gas flow rate measurement in the pipe may include determination of the value of the Lockhart-Martinelli parameter using one or more machine-learning models. For example, in addition to or alternative to the determination of the value of the Lockhart-Martinelli parameter set forth above, the values of the Lockhart-Martinelli parameter may be determined using machine-learning model(s). The machine-learning model(s) may be trained using one or more types of values as inputs (input features) and the value of the Lockhart-Martinelli parameter as output (target variable). As another example, the values of liquid Froude number may be determined using machine-learning model(s). The machine-learning model(s) may be trained using one or more types of values as inputs (input features) and the value of the liquid Froude number as output (target variable). In some implementations, the machine-learning model(s) may include one or more random forest models. Other types of machine-learning model(s) are contemplated. In some implementations, the machine-learning model(s) may be trained using gradient boosting, such as XGBoost. Use of other training algorithms is contemplated.

The machine-learning model(s) may be trained to receive as input the pressure loss ratio and the ideal pressure loss ratio, and/or other information. The machine-learning model(s) may output the value of the Lockhart-Martinelli parameter based on the difference between the pressure loss ratio and the ideal pressure loss ratio (the pressure loss ratio departure from single-phase flow, Y_{PLR}) and/or other information that the machine-learning model(s) receives as input. For example, the machine-learning model(s) may be trained to output the value of the Lockhart-Martinelli parameter based on input of the difference between the pressure loss ratio and the ideal pressure loss ratio.

The machine-learning model(s) may be trained to output the value of the Lockhart-Martinelli parameter based on input of the pressure loss ratio departure from single-phase flow itself and/or other quantit(ies) that include/incorporate the pressure loss ratio departure from single-phase flow. For instance, the machine-learning model(s) may be trained to output the value of the Lockhart-Martinelli parameter based on input of a ratio of the pressure loss ratio departure from single-phase flow to the geometry of the pipe.

$$Input : \frac{{Y}_{PLR}}{{β}^{4}}$$

where

$$β = \frac{d}{D} ,$$

d=orifice diameter, D=pipe diameter where

The machine-learning model(s) may be trained to output the value of the Lockhart-Martinelli parameter based on input of other types of values. The ratio of the pressure loss ratio departure from single-phase flow to the geometry of the pipe may have greater effect on the machine-learning model(s) to output the value of the Lockhart-Martinelli parameter than other types of values. Examples of other types of values that may be used for the machine-learning models include DR*Y (where Y is a scaled value of Y_{PLR}), DR*Y_{PLR},

$${Y}_{PLR}^{2} ,$$

Y/β, pressure at upstream location(s), pressure at downstream location(s), PLR_{single-phase}. PLR_{measured}, operating temperature, gas inlet pressure, gas density ρ_{g}, liquid density ρₗ, differential pressure between two locations such as third-tap differential pressure ΔP_{third tap}, flow restriction (e.g., orifice plate) differential pressure ΔP_{restriction}, statistics for one or more of the previous values (e.g., standard deviation, 90% percentile, and/or 10% percentile of pressure). Values used for the machine-learning models may be scaled and/or transformed (e.g., normalizing, quantile normalization, rescaling). Other inputs to the machine-learning model(s) are contemplated.

The correction component 112 may be configured to determine a liquid-corrected gas flow rate in the pipe. Determining the liquid-corrected gas flow rate in the pipe may include ascertaining, approximating, calculating, establishing, estimating, finding, identifying, obtaining, quantifying, selecting, setting, and/or otherwise determining the liquid-corrected gas flow rate in the pipe. Determining a liquid-corrected gas flow rate in the pipe may include determining the value of the liquid-corrected gas flow rate in the pipe. A liquid-corrected gas flow rate in the pipe may refer to a gas flow rate that has been corrected to account for the presence of liquid in the pipe. A liquid-corrected gas flow rate in the pipe may refer to a gas flow rate that has been adjusted from the measured gas flow rate to account for the error in gas flow rate measurement due to the presence of liquid in the pipe.

The liquid-corrected gas flow rate in the pipe may be determined based on the overread or the underread of gas flow rate measurement in the pipe, the measured gas flow rate in the pipe, and/or other information. The overread or the underread of gas flow rate measurement in the pipe may be used to correct the measured gas flow rate in the pipe. The measured gas flow rate may be corrected for the overread/underread to calculate the liquid-corrected gas flow rate in the pipe. For example, the mass flow rate of gas measured in the pipe (m_{g,measured}) may be corrected for the overread to calculate the liquid-corrected mass flow rate of gas (m_{g,corrected}) as set forth below. The volume flow rate of gas may be measured and corrected using the overread. The underread may be used to correct the mass flow rate and/or volume flow rate of gas in the pipe in the same/similar way. In some implementations, liquid-corrected volume flow rate of gas may be determined based on the liquid-corrected mass flow rate of gas, or vice versa. Other correction of the gas flow rate in the pipe is contemplated.

$${m}_{g , corrected} = \frac{{m}_{g , measured}}{OR} , {Q}_{g} = \frac{{m}_{g , corrected}}{{ρ}_{g}}$$

In some implementations, total transferred gas over a time period may be determined based on the liquid-corrected gas flow rate and/or other information. Total transferred gas over a time period may refer to the total amount of gas that is transferred over the time period using the pipe. The liquid-corrected gas flow rate may be multiplied by the time period to accurately determine how much gas has been transferred over the time period using the pipe. Such determination of the total transferred gas over the time period may enable more accurate tracking of gas transfer (e.g., for billing purposes) and/or more accurate control/allocation of gas transfer.

In some implementations, operation of the pipe (gas pipeline) may be controlled (e.g., started, stopped, set, changed) based on the liquid-corrected gas flow rate, the total transferred gas over a time period, and/or other information. For example, the type of gas that is transferred over the pipe and/or the rate of the gas flow through the pipe may be controlled based on the liquid-corrected gas flow rate, the total transferred gas over a time period, and/or other information. For instance, the rate of the gas flow through the pipe may be increased, slowed, or stopped based on the liquid-corrected gas flow rate, the total transferred gas over a time period, and/or other information. Allocation of revenue from gas and liquid may be altered based on the corrected gas rate and the liquid flow rate. Operating conditions may be altered to ensure that no liquid is present in the gas pipeline. The liquid may be removed by automated action in the operation.

In some implementations, the correction component 112 may be configured to determine a liquid flow rate in the pipe. Determining a liquid flow rate in the pipe may include ascertaining, approximating, calculating, establishing, estimating, finding, identifying, obtaining, quantifying, selecting, setting, and/or otherwise determining the liquid flow rate in the pipe. Determining a liquid flow rate in the pipe may include determining the value of the liquid flow rate in the pipe. A liquid flow rate in the pipe may refer to a rate at which liquid is flowing through the pipe (e.g., by mass, by volume).

In some implementations, the liquid flow rate in the pipe may be determined based on the liquid-corrected gas flow rate, the value of the Lockhart-Martinelli parameter, and/or other information. The mass flow rate of liquid (mₗ) in the pipe may be calculated using the liquid-corrected gas flow rate (m_{g}), the value of the Lockhart-Martinelli parameter, and the density ratio of liquid and gas (ρₗ/ρ_{g}) as set forth below. Other calculations of the liquid flow rate in the pipe are contemplated.

$${m}_{l} = {X}_{LM} \cdot {m}_{g} \sqrt{\frac{{ρ}_{l}}{{ρ}_{g}}}$$

In some implementations, the liquid flow rate may be determined based on the liquid Froude number and/or other information. The superficial liquid velocity may be determined based on the liquid Froude number and/or other information. The liquid flow rate may be determined based on the superficial liquid velocity and/or other information. For example, the liquid mass flow rate may be determined as a product of the superficial liquid velocity, density of liquid, and cross-sectional area of the pipe. Other determinations of the liquid flow rate are contemplated.

In some implementations, total transferred liquid over a time period may be determined based on the liquid flow rate and/or other information. Total transferred liquid over a time period may refer to the total amount of liquid that is transferred over the time period using the pipe. The liquid flow rate may be multiplied by the time period to accurately determine how much liquid has been transferred over the time period using the pipe. Such determination of the total transferred liquid over the time period may enable more accurate tracking of liquid transfer (e.g., for billing purposes) and/or more accurate control/allocation of liquid transfer.

In some implementations, operation of the pipe (gas pipeline) may be controlled (e.g., started, stopped, set, changed) based on the liquid flow rate, the total transferred liquid over a time period, and/or other information. For example, the type of gas that is transferred over the pipe and/or the rate of the gas flow through the pipe may be controlled based on the liquid flow rate, the total transferred liquid over a time period, and/or other information. For instance, the rate of the gas flow through the pipe may be increased, slowed, or stopped based on the liquid flow rate, the total transferred liquid over a time period, and/or other information. Allocation of revenue from gas and liquid may be altered based on the corrected gas rate and the liquid rate. Operating conditions may be altered to ensure that no liquid is present in the gas pipeline. The liquid may be removed by automated action in the operation.

While the present disclosure has been described with usage of pressure sensors and flow sensors, use of other types of sensors is contemplated. Other types of sensors may be used in conjunction with or separately from pressure sensors and/or flow sensors.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). A machine-readable medium may include a non-transitory computer-readable medium. For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software, hardware, firmware; some combination of software, hardware, and/or firmware; and/or other mechanisms for configuring processing capabilities on the processor 11. The system 10 may be implemented in a single computing device, across multiple computing devices, in a client-server environment, in a cloud environment, and/or in other devices/configuration of devices. The system 10 may be implemented using a computer, a desktop, a laptop, a phone, a tablet, a mobile device, a server, and/or other computing devices.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

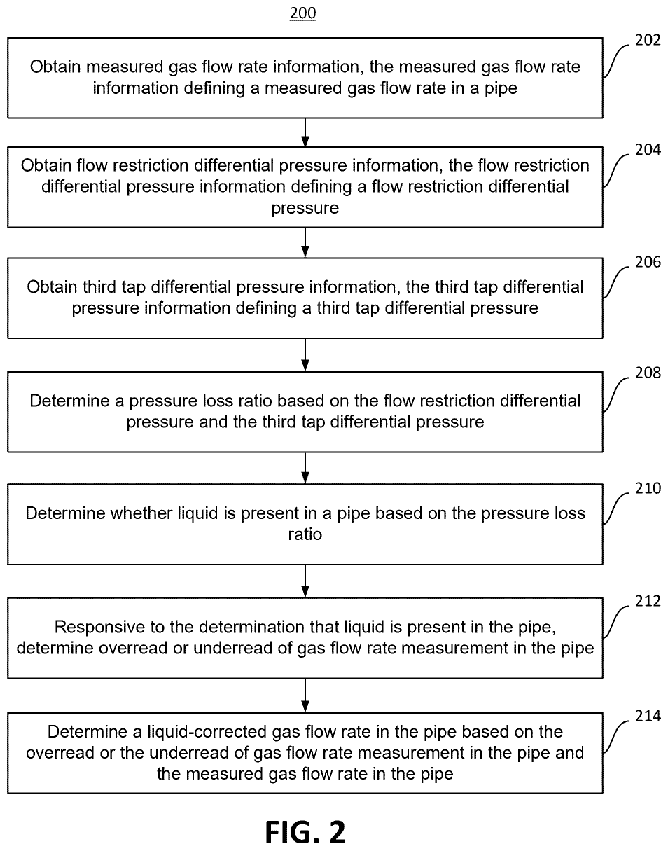

FIG. 2 illustrates method 200 for correcting gas flow rate in the presence of liquid in a gas pipeline. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, measured gas flow rate information may be obtained. The measured gas flow rate information may define a measured gas flow rate in a pipe. The pipe may include a flow restriction. In some implementations, operation 202 may be performed by a processor component the same as or similar to the flow rate component 102 (Shown in FIG. 1 and described herein).

At operation 204, flow restriction differential pressure information may be obtained. The flow restriction differential pressure information may define a flow restriction differential pressure between a first point along the pipe and a second point along the pipe. The first point may be on a first side of the flow restriction and the second point may be on a second side of the flow restriction. In some implementations, operation 204 may be performed by a processor component the same as or similar to the differential pressure component 104 (Shown in FIG. 1 and described herein).

At operation 206, third tap differential pressure information may be obtained. The third tap differential pressure information may define a third tap differential pressure between the first point along the pipe and a third point along the pipe. The third point may be on the second side of the flow restriction and may be downstream of the second point. In some implementations, operation 206 may be performed by a processor component the same as or similar to the differential pressure component 104 (Shown in FIG. 1 and described herein).

At operation 208, a pressure loss ratio may be determined based on the flow restriction differential pressure, the third tap differential pressure, and/or other information. In some implementations, operation 208 may be performed by a processor component the same as or similar to the pressure loss ratio component 106 (Shown in FIG. 1 and described herein).

At operation 210, whether liquid is present in the pipe may be determined based on the pressure loss ratio and/or other information. In some implementations, operation 208 may be performed using a processor component the same as or similar to the liquid presence component 108 (Shown in FIG. 1 and described herein).

At operation 212, responsive to the determination that liquid is present in the pipe, overread or underread of gas flow rate measurement in the pipe may be determined. In some implementations, operation 212 may be performed using a processor component the same as or similar to the overread/underread component 110 (Shown in FIG. 1 and described herein).

At operation 214, a liquid-corrected gas flow rate in the pipe may be determined based on the overread or the underread of gas flow rate measurement in the pipe, the measured gas flow rate in the pipe, and/or other information. In some implementations, operation 214 may be performed using a processor component the same as or similar to the correction component 112 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for correcting gas flow rate in the presence of liquid in a gas pipeline, the system comprising:
one or more physical processors configured by machine-readable instructions to:
obtain measured gas flow rate information, the measured gas flow rate information defining a measured gas flow rate in a pipe, the pipe including a flow restriction;
obtain flow restriction differential pressure information, the flow restriction differential pressure information defining a flow restriction differential pressure between a first point along the pipe and a second point along the pipe, the first point being on a first side of the flow restriction and the second point being on a second side of the flow restriction;
obtain third tap differential pressure information, the third tap differential pressure information defining a third tap differential pressure between the first point along the pipe and a third point along the pipe, the third point being on the second side of the flow restriction and being downstream of the second point;
determine a pressure loss ratio based on the flow restriction differential pressure and the third tap differential pressure;
determine whether liquid is present in the pipe based on the pressure loss ratio;
responsive to the determination that liquid is present in the pipe,
determine overread or underread of gas flow rate measurement in the pipe; and
determine a liquid-corrected gas flow rate in the pipe based on the overread or the underread of gas flow rate measurement in the pipe and the measured gas flow rate in the pipe.

2. The system of claim 1, wherein determination of the overread or the underread of gas flow rate measurement in the pipe includes:
determination of a value of Lockhart-Martinelli parameter based on a difference between the pressure loss ratio and an ideal pressure loss ratio;
determination of an estimated value of the overread or the underread of gas flow rate measurement;
determination of a corrected gas flow rate based on the estimated value of the overread or the underread of gas flow rate measurement;
determination of a value of a gas Froude number based on the corrected gas flow rate; and
determination of a calculated value of the overread or the underread of gas flow rate measurement based on the value of the Lockhart-Martinelli parameter and the value of the gas Froude number.

3. The system of claim 2, wherein the determinations of the corrected gas flow rate, the value of the gas Froude number, and the calculated value of the overread or the underread of gas flow rate measurement are iterated based on a comparison of the estimated value of the overread or the underread of gas flow rate measurement and the calculated value of the overread or the underread of gas flow rate measurement.

4. The system of claim 1, wherein determination of the overread or the underread of gas flow rate measurement in the pipe includes:
determination of a value of liquid Froude number based on a difference between the pressure loss ratio and an ideal pressure loss ratio;
determination of a liquid flow rate based on the value of the liquid Froude number;
determination of an estimated value of the overread or the underread of gas flow rate measurement;
determination of a corrected gas flow rate based on the estimated value of the overread or the underread of gas flow rate measurement;
determination of a value of a gas Froude number based on the corrected gas flow rate;
determination of a value of Lockhart-Martinelli parameter; and
determination of a calculated value of the overread or the underread of gas flow rate measurement based on the value of the Lockhart-Martinelli parameter and the value of the gas Froude number.

5. The system of claim 4, wherein the determinations of the corrected gas flow rate, the value of the gas Froude number, the value of the Lockhart-Martinelli parameter, and the calculated value of the overread or the underread of gas flow rate measurement are iterated based on a comparison of the estimated value of the overread or the underread of gas flow rate measurement and the calculated value of the overread or the underread of gas flow rate measurement.

6. The system of claim 1, wherein determination of the overread or the underread of gas flow rate measurement in the pipe includes:
determination of a value of Lockhart-Martinelli parameter using a machine-learning model, the machine-learning model outputting the value of the Lockhart-Martinelli parameter based on a difference between the pressure loss ratio and an ideal pressure loss ratio.

7. The system of claim 6, wherein the machine-learning model is trained to output the value of the Lockhart-Martinelli parameter based on input of a ratio of the difference between the pressure loss ratio and the ideal pressure loss ratio to geometry of the pipe.

8. The system of claim 6, wherein the machine-learning model includes a random forest model or an XGBoost model.

9. The system of claim 1, wherein the one or more physical processors are further configured by the machine-readable instructions to determine a liquid flow rate in the pipe based on the liquid-corrected gas flow rate and the value of the Lockhart-Martinelli parameter.

10. The system of claim 9, wherein total transferred liquid over a time period is determined based on the liquid flow rate.

11. The system of claim 1, wherein total transferred gas over a time period is determined based on the liquid-corrected gas flow rate.

12. A method for correcting gas flow rate in the presence of liquid in a gas pipeline, the method comprising:
obtaining measured gas flow rate information, the measured gas flow rate information defining a measured gas flow rate in a pipe, the pipe including a flow restriction;
obtaining flow restriction differential pressure information, the flow restriction differential pressure information defining a flow restriction differential pressure between a first point along the pipe and a second point along the pipe, the first point being on a first side of the flow restriction and the second point being on a second side of the flow restriction;
obtaining third tap differential pressure information, the third tap differential pressure information defining a third tap differential pressure between the first point along the pipe and a third point along the pipe, the third point being on the second side of the flow restriction and being downstream of the second point;
determining a pressure loss ratio based on the flow restriction differential pressure and the third tap differential pressure;
determining whether liquid is present in the pipe based on the pressure loss ratio;
responsive to determining that liquid is present in the pipe, determining overread or underread of gas flow rate measurement in the pipe; and
determining a liquid-corrected gas flow rate in the pipe based on the overread or the underread of gas flow rate measurement in the pipe and the measured gas flow rate in the pipe.

13. The method of claim 12, wherein determining the overread or the underread of gas flow rate measurement in the pipe includes:
determining a value of Lockhart-Martinelli parameter based on a difference between the pressure loss ratio and an ideal pressure loss ratio;
determining an estimated value of the overread or the underread of gas flow rate measurement;
determining a corrected gas flow rate based on the estimated value of the overread or the underread of gas flow rate measurement;
determining a value of a gas Froude number based on the corrected gas flow rate; and
determining a calculated value of the overread or the underread of gas flow rate measurement based on the value of the Lockhart-Martinelli parameter and the value of the gas Froude number.

14. The method of claim 13, wherein determining the corrected gas flow rate, the value of the gas Froude number, and the calculated value of the overread or the underread of gas flow rate measurement are iterated based on a comparison of the estimated value of the overread or the underread of gas flow rate measurement and the calculated value of the overread or the underread of gas flow rate measurement.

15. The method of claim 12, wherein determining the overread or the underread of gas flow rate measurement in the pipe includes:
determining a value of liquid Froude number based on a difference between the pressure loss ratio and an ideal pressure loss ratio;
determining a liquid flow rate based on the value of the liquid Froude number;
determining an estimated value of the overread or the underread of gas flow rate measurement;
determining a corrected gas flow rate based on the estimated value of the overread or the underread of gas flow rate measurement;
determining a value of a gas Froude number based on the corrected gas flow rate;
determining a value of Lockhart-Martinelli parameter; and
determining a calculated value of the overread or the underread of gas flow rate measurement based on the value of the Lockhart-Martinelli parameter and the value of the gas Froude number.

16. The method of claim 15, wherein determining the corrected gas flow rate, the value of the gas Froude number, the value of the Lockhart-Martinelli parameter, and the calculated value of the overread or the underread of gas flow rate measurement are iterated based on a comparison of the estimated value of the overread or the underread of gas flow rate measurement and the calculated value of the overread or the underread of gas flow rate measurement.

17. The method of claim 12, wherein determining the overread or the underread of gas flow rate measurement in the pipe includes:
determining a value of Lockhart-Martinelli parameter using a machine-learning model, the machine-learning model outputting the value of the Lockhart-Martinelli parameter based on a difference between the pressure loss ratio and an ideal pressure loss ratio.

18. The method of claim 17, wherein the machine-learning model is trained to output the value of the Lockhart-Martinelli parameter based on input of a ratio of the difference between the pressure loss ratio and the ideal pressure loss ratio to geometry of the pipe.

19. The method of claim 17, wherein the machine-learning model includes a random forest model or an XGBoost model.

20. The method of claim 12, further comprising: determining a liquid flow rate in the pipe based on the liquid-corrected gas flow rate and the value of the Lockhart-Martinelli parameter.
